(19) United States
(12) Patent Application Publication
(10) Pub. No.: US 2003/0033217 A1
(43) Pub. Date: Feb. 13, 2003

(54) Method and system for mapping shelf space

(75) Inventor: Robert R. Cutlip, Apex, NC (US)

Correspondence Address: IBM Corporation T81/503, P.O. Box 12195, Research Triangle Park, NC, 27709, US

(73) Assignee: International Business Machines Corporation, Armonk, NY (US)

(21) Appl. No.: 09/860,201

(22) Filed: May 18, 2001

(51) Int. Cl. G06F 17/60

(52) U.S. Cl. 705/27

(57) ABSTRACT

A system for implementing a method for mapping a shelf is disclosed. The system comprises a relational database management system including spatial data types whereby the shelf is established as a geographical entity in terms of a location of the shelf within an isle, a location of the isle within a structure, and a duration of any product on the shelf. The system further comprises a spatial extender access module including user defined functions for accessing the geographical entity.

### BACKGROUND OF THE INVENTION

1. Field Of The Invention

The present invention generally relates to mapping objects within a known area. The present invention more particularly relates to mapping shelf space within a spatial reference system.

2. Description of the Related Art

The ability of retailers to associate a product located on a particular shelf as well as sales data, sales data relative to position, sales data relative to position of other products, inventory control, relating shelf position to wholesalers and wholesaler incentive programs is beneficial to a retailer's formulation of business plans. As such, there are prior art systems for associating the product with a particular shelf.

For example, U.S. Pat. No. 6,026,377 discloses a system comprising a retail space management system, a product database, and a three-dimensional modeling and display system. The retail space management system generates information describing product and shelf sizes and locations in three dimensions. The product database stores images of product packages. The three-dimensional modeling and display system retrieves size and location information from the retail space management system and generates three-dimensional models of each shelf and product.

Also by example, U.S. Pat. No. 5,920,261 discloses a system comprises transponders, transmitters, receivers and a location processor. A transponder can be attached to each product on a shelf. The transponder are periodically interrogated by the transmitters. The receivers receive and direct transponder signals to the location processor whereby the location processor can locate the position of each object on the shelf.

The present invention is an advancement of the technology utilized in the prior art systems.

### SUMMARY OF THE INVENTION

The present invention relates to a method and a system for mapping shelf space. Various aspects of the present invention are novel, non-obvious, and provide various advantages. While the actual nature of the present invention covered herein can only be determined with reference to the claims appended hereto, certain features, which are characteristic of the embodiments disclosed herein, are described briefly as follows.

One form of the present invention is a method for mapping a product located on a shelf within an isle contained within a structure. First, a spatial reference system encompassing the shelf based upon a coordinate reference system encompassing an interior of the structure is established. And, second, the shelf as a geographical entity within the spatial reference system is established in terms of a position of the shelf within the isle, a location of the isle within the structure, and a duration of a product on the shelf.

A second form of the present invention is a system for mapping a product located on a shelf within an isle contained within a structure. The system comprises a computer and a relational database. The computer is operable to control an establishment of a spatial reference system encompassing the shelf based upon a coordinate reference system encompassing an interior of the structure. The computer is further operable to control an establishment of the shelf as a geographical entity within the spatial reference system in terms of a position of the shelf within the isle, a location of the isle within the structure, and a duration of a product on the shelf. The relational database is operable to store spatial data corresponding to the geographical entity.

A third form of the present invention is a computer program product in a computer readable medium for mapping a product located on a shelf within an isle contained within a structure. The computer program product comprises computer readable code for establishing a spatial reference system encompassing the shelf based upon a coordinate reference system encompassing an interior of the structure. The computer program product further comprises computer readable code for establishing the shelf as a geographical entity within the spatial reference system in terms of a position of the shelf within the isle, a location of the isle within the structure, and a duration of a product on the shelf.

The foregoing forms and other forms, features and advantages of the invention will become further apparent from the following detailed description of the presently preferred embodiments, read in conjunction with the accompanying drawings. The detailed description and drawings are merely illustrative of the invention rather than limiting, the scope of the invention being defined by the appended claims and equivalents thereof.

### BRIEF DESCRIPTION OF THE DRAWINGS

FIG. 1 is block diagram of one embodiment of a computer system employed in the present invention;

FIG. 2 is a block diagram of one embodiment of a computer software employed in the FIG. 1 computer system;

FIG. 3 is a flow chart of one embodiment of a shelf mapping routine in accordance with the present invention;

FIG. 4 illustrates an exemplary three-dimensional coordinate reference system of a structure in accordance with the present invention;

FIG. 5 illustrates an exemplary three-dimensional spatial reference system of a structure in accordance with the present invention;

FIG. 6 illustrates an exemplary two-dimensional spatial reference system of a time component in accordance with the present invention;

FIG. 7A illustrates a hierarchy of spatial data types system in accordance with one embodiment of the present invention;

FIG. 7B illustrates a first branch of the FIG. 7A hierarchy of spatial data types in accordance with the present invention;

FIG. 7C illustrates a second branch of the FIG. 7A hierarchy of data types in accordance with the present invention; and

FIG. 7D illustrates a third branch of the FIG. 7A hierarchy of data types in accordance with the present invention.

### DETAILED DESCRIPTION OF THE PRESENTLY PREFERRED EMBODIMENTS

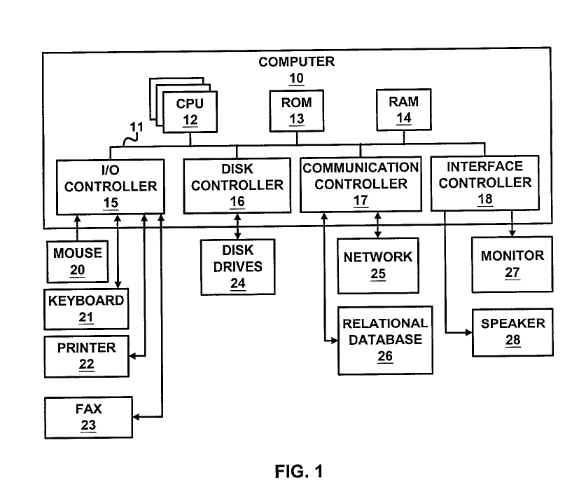

A computer 10 of the present invention is shown in FIG. 1. Referring to FIG. 1, computer 10 may be configured in any form for accepting structured inputs, processing the inputs in accordance with prescribed rules, and outputting the processing results as would occur to those having ordinary skill in the art, such as, for example, a personal computer, a workstation, a super computer, a mainframe computer, a minicomputer, a super minicomputer, and a microcomputer. Preferably, as shown, computer 10 is a server including a bus 11 for facilitating electrical communication among one or more central processing units (CPU) 12, a read-only memory (ROM) 13, a random access memory (RAM) 14, an input/output (I/O) controller 15, a disk controller 16, a communication controller 17, and a user interface controller 18.

CPU 12 is preferably one of the Intel families of microprocessors, one of the AMD families of microprocessors, one of the Motorola families of microprocessors, or one of the various versions of a Reduced Instruction Set Computer microprocessor such as the PowerPC chip manufactured by International Business Machine Corporation (IBM). ROM 13 stores various controlling programs such as the Basic Input-Output System (BIOS) developed by IBM. RAM 14 is the memory for loading an operating system and selectively loading controlling and application programs.

Controller 15 is an aggregate of controllers for facilitating an interaction between CPU 12 and pointing devices such as a mouse 20 and a keyboard 21, and between CPU 12 and output devices such as a printer 22 and a fax 23. Controller 16 is an aggregate of controllers for facilitating an interaction between CPU 12 and data storage devices such as disks drives 24 in the form of a hard drive, a floppy drive, a local drive, and a compact-disc drive. The hard drive of disk drives 24 stores a conventional operating system. Controller 17 is an aggregate of controllers for facilitating an interaction between CPU 12 and a network 25, and between CPU 12 and an object-relational database 26 stored on a local or remote storage device. Controller 18 is an aggregate of controllers for facilitating an interaction between CPU 12 and a graphic display device such as a monitor 27, and between CPU 12 and an audio device such as a speaker 28.

Those having skill in the art will appreciate alternative computer hardware embodiments of computer 10 for implementing the principles of the present invention.

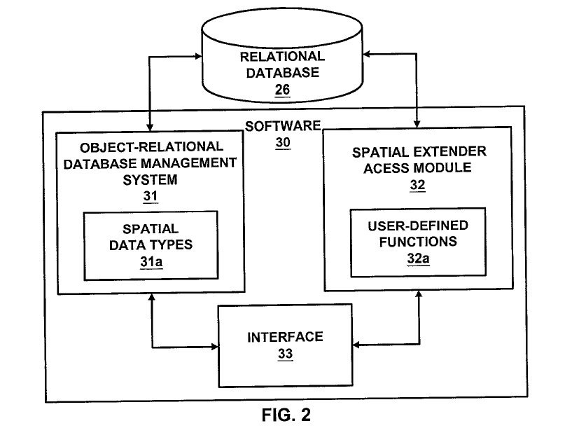

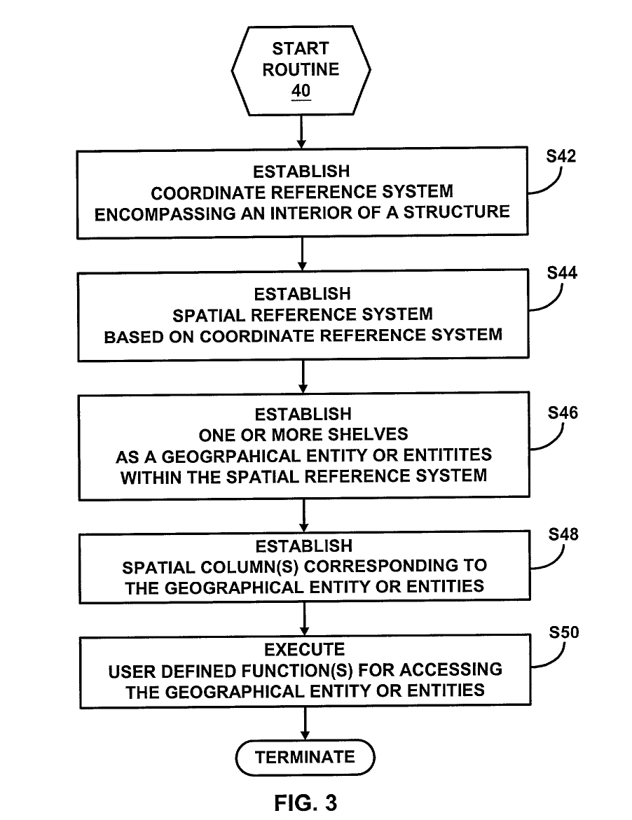

Referring additionally to FIG. 2, computer 10 includes software 30 for implementing a shelf mapping routine 40 (FIG. 3) under control of the operating system. Software 30 is a computer program physically stored within a hard drive of disk drives 24 whereby the hard drive is a computer readable medium that is electrically, magnetically, optically, or chemically altered to store computer readable code. In other embodiments of computer 10, software 30 can be stored in other computer readable mediums of computer 10, such as the CD-ROM drive of disk drives 24 and the object-relational database 26 as stored on a local or remote storage device, or software 30 or portions thereof can be downloaded to RAM 14 via network 25. Also in other embodiments of computer 10, software 30 can be partially or fully implemented with digital circuitry, analog circuitry, or both.

Software 30 includes an object-relational database management system (DMS) 31 including spatial data types 31a, a spatial extender access module 32 including user-defined functions 32a, and a conventional interface 33 (e.g., a graphical user interface and/or a network interface) for establishing communication with monitor 27 and/or network 25. In one embodiment of software 30, RDMS 31 and module 32 incorporate a Structured Query Language (SQL) interface. An execution of RDMS 31 under control of the operating system facilitates a storage of business data within object-relational database 26 as would occur to those skilled in the art. An execution of spatial extender access module 32 under control of the operating system facilitates a storage of spatial data and objects within object-relational database 26 as well as a querying of the spatial data and object as would occur to those skilled in the art.

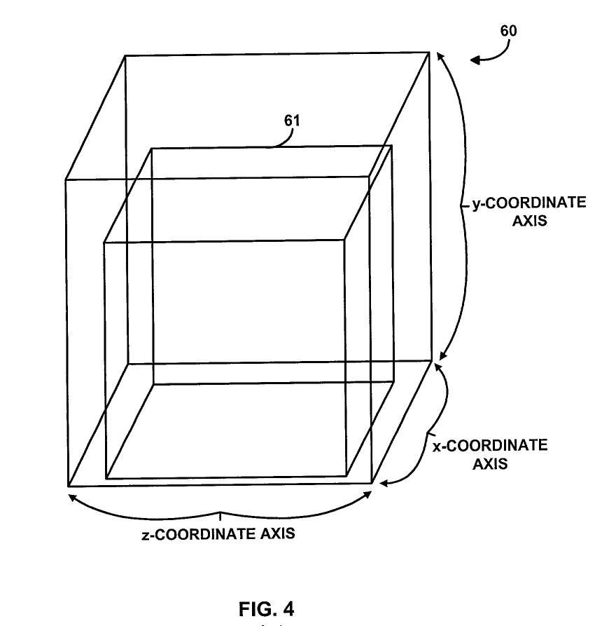

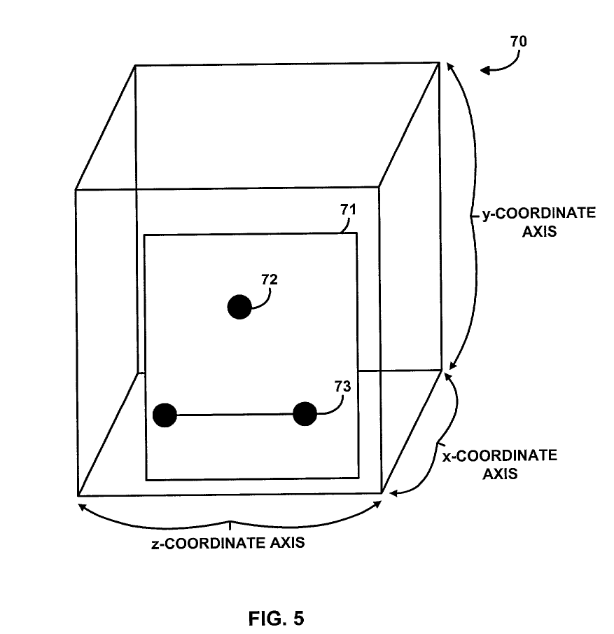

Referring additionally to FIG. 3, the present invention is a directed to a method for mapping shelf space that can be implemented as a shelf mapping routine 40 by a geographic information system (GIS) such as module 32. During a stage S42 of routine 40, a coordinate reference system encompassing an interior of a structure (e.g., a retail location, a warehouse, and the like) is established (i.e., generated, retrieved, and/or imported). In one embodiment, a three-dimensional coordinate reference system (CRS) 60 corresponding to a structure is established as shown in FIG. 4. CRS 60 encompasses an interior of the structure, which contains an isle 61 therein as shown in block form. Those skilled in the art will appreciate that the x-coordinate axis, the y-coordinate axis, and the z-coordinate axis of CRS 60 contain non-integer coordinates and may contain negative coordinates. During a stage S44 of routine 40, CRS 60 serves as a basis for an establishment of a spatial reference system encompassing the interior of the structure. In one embodiment, a three-dimensional spatial reference system (SRS) 70 based from CRS 60 is established as shown in FIG. 5. Those skilled in the art will appreciate that the Spatial Reference System (SREF) assures that x-coordinate axis, the y-coordinate axis, and the z-coordinate axis of SRS 70 will not be stored within the relational database system as non-integer coordinates or negative coordinates. Additionally, a two-dimensional spatial reference system (SRS) 74 including an x-coordinate axis in terms of years having coordinates as positive integers and a y-coordinate axis in terms of days having coordinates as positive integers can be established during stage S44.

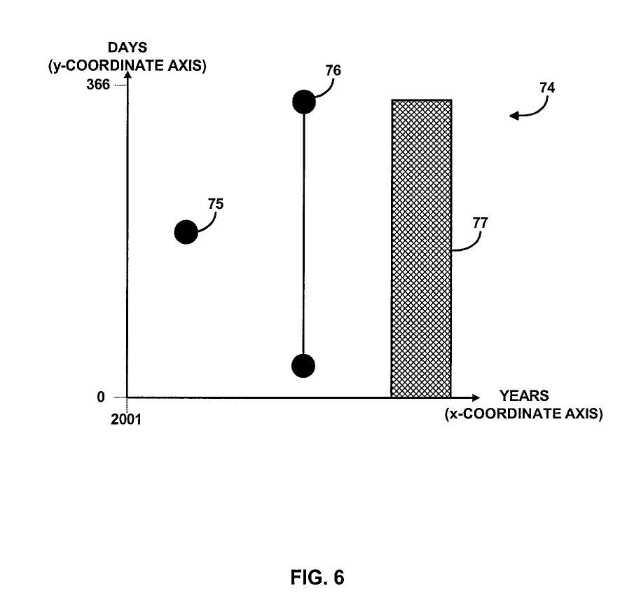

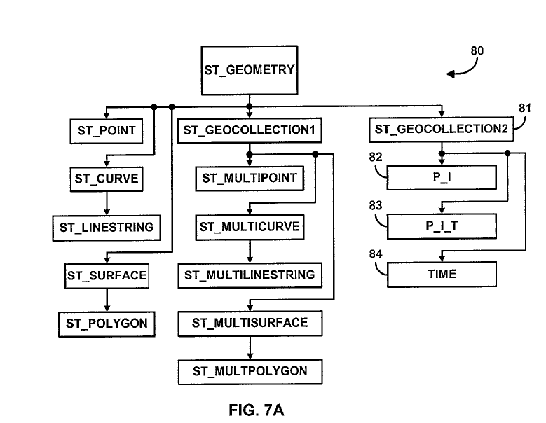

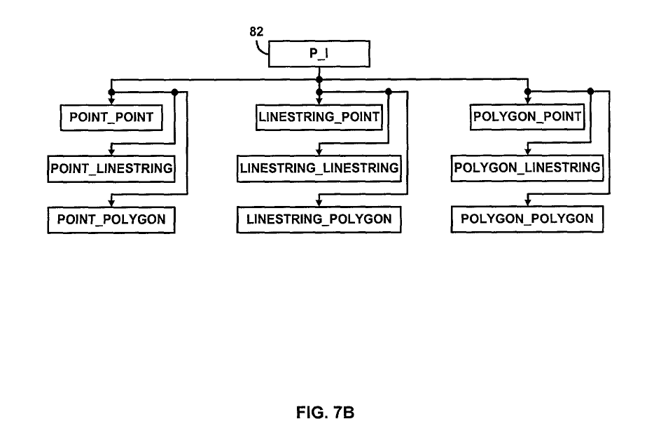

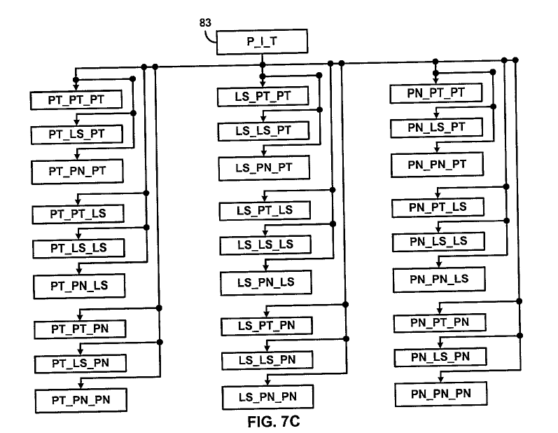

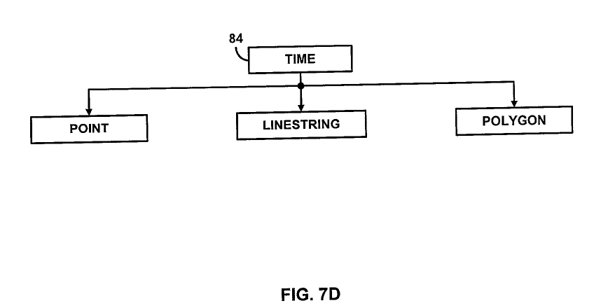

During a stage S46 of routine 40, one or more shelves and one or more isles within the structure are established as geographical entities within a spatial reference system encompassing the shelve(s) and isle(s). In one embodiment, the types of geographical entities include point(s), line string(s), and polygon(s). For example, a polygon 71 as shown in FIG. 5 is established in SRS 70 as a geographical representation of isle 61 in FIG. 4. Additionally, a location on one of the shelves on isle 61 is geographical represented as a point 72, and another shelf of isle 61 is geographical represented by a linestring 73. Furthermore, a time component indicating a duration of a product on a shelf can be represented as a point 75, a linestring 76, or a polygon 77 as shown in FIG. 6. In one embodiment, the basis for establishing one or more geographical entities within the spatial reference system are spatial data types 32a (FIG. 2) which are extensions of a well established hierarchy 80 of spatial data types shown in FIG. 7A.

Referring to FIG. 7A, spatial data types 32a includes a non-instantiable form of a ST-GEOCOLLECTION2 data type 81 having of a P_I data type 82, a P_I_T data type 83, and a Time data type 84 in non-instantiable form. P_I data type 82 includes data types in instantiable form as shown in FIG. 7B to thereby define a position P of a shelf within an isle (e.g., point 72 or linestring 73 of FIG. 5) and a location of an isle I within a structure (e.g., polygon 71 of FIG. 5). P_I_T data type 83 includes data types in instantiable form as shown in FIG. 7C to thereby define position P of a shelf within an isle, a location of an isle I within a structure, and a duration T of a product on the shelf. In FIG. 7C, PT is an abbreviation for point, LS is an abbreviation of linestring, and PN is an abbreviation of Polygon. Time data type 84 includes data types in instantiable form as shown in FIG. 7D to a duration T of a product on the shelf (e.g., point 75, linestring 76, and polygon 77 of FIG. 6).

During a stage S47 of routine 40, one or more spatial columns corresponding to the spatial reference system(s) are established within object-relational database 26. For example, the following TABLE 1 illustrates an exemplary attribute column labeled UPC containing the Universal Product Code associated with a product, a product number or some other unique identifier, and an exemplary spatial column labeled LOCATION containing a Data Type extension that describes a products position in space and time.

TABLE 1

| UPC | LOCATION |
|---|---|
| xxx1 | <P, I, T>₁ |
| xxx2 | <P, I, T>₂ |
| Xxx3 | <P, I, T>₃ |
| Xxx4 | <P, I, T>₄ |

P is the coordinates of SRS 70 indicating a location of the corresponding shelf on an isle, I is the coordinate of SRS 70 indicating a location of the isle within SRS 70, and T is the coordinate of SRS 74 indicating a duration of a product in the corresponding shelf. Indices may be provided to facilitate access to the location column or its sub-elements.

Also by example, the following TABLE 2 illustrates an exemplary attribute column labeled UPC storing attribute data therein as well as a pair of exemplary spatial columns labeled POSITION LOCATION and TIME LOCATION having spatial data geocoded and stored therein:

TABLE 2

| | POSITION | TIME |
|---|---|---|
| UPC | LOCATION | LOCATION |
| xxx1 | <P I>₁ | <T>₁ |
| xxx2 | <P I>₂ | <T>₂ |
| xxx3 | <P I>₃ | <T>₃ |
| xxx4 | <P I>₄ | <T>₄ |

Indices may be provided (e.g., Idx_PI, Idx_T) to facilitate access to the location columns.

During a stage S50 of routine 40, user defined functions 32a for accessing one or more geographical entities are executed. Routine 40 is terminated upon completion of stage S50. Those having ordinary skill in the art will appreciate the advantages of routine 40, such as, for example, an association of a product on a particular shelf; an ability to leverage spatial functions (e.g., distance functions) relative to product(s) on the shelves; and an ability to leverage business data with spatial data including a time component to associate product position and product time with business data like sales.

While the embodiments of the present invention disclosed herein are presently considered to be preferred, various changes and modifications can be made without departing from the spirit and scope of the invention. The scope of the invention is indicated in the appended claims, and all changes that come within the meaning and range of equivalents are intended to be embraced therein.

We claim:

1. A method for mapping a product located on a shelf within an isle contained within a structure, said method comprising:
establishing a spatial reference system encompassing the shelf based upon a coordinate reference system encompassing an interior of the structure; and
establishing the shelf as a geographical entity within the spatial reference system in terms of a position of the shelf within the isle, a location of the isle within the structure, and a duration of the product on the shelf.

2. The method of claim 1, further comprising:
establishing a spatial column for storing a set of spatial data corresponding to the geographical entity.

3. The method of claim 2, further comprising:
establishing an attribute column for storing attribute data corresponding to the product located on the shelf.

4. The method of claim 1, further comprising:
establishing a first spatial column for storing a first set of spatial data corresponding to the position of the shelf within the isle and the location of the isle within the structure;
establishing a second spatial column for storing a second set of spatial data corresponding to a duration of the product on the shelf.

5. The method of claim 4, further comprising:
establishing an attribute column for storing attribute data corresponding to the product located on the shelf.

6. A system for mapping a product located on a shelf within an isle contained within a structure, said method comprising:
a computer operable to control an establishment of a spatial reference system encompassing the shelf based upon a coordinate reference system encompassing an interior of the structure, said computer further operable to control an establishment of the shelf as a geographical entity within the spatial reference system in terms of a position of the shelf within the isle, a location of the isle within the structure, and a duration of a product on the shelf; and
a relational database operable to store spatial data corresponding to the geographical entity.

7. The system of claim 6, wherein
said computer is further operable to control an establishment of a spatial column within the relational database for storing the spatial data corresponding to the geographical entity.

8. The system of claim 7, wherein
said computer is further operable to control an establishment of an attribute column within the relational database for storing attribute data corresponding to the product located on the shelf.

9. The system of claim 6, wherein
said computer is further operable to control an establishment of a first spatial column within the relational database for storing a first set of spatial data corresponding to the position of the shelf within the isle and the location of the isle within the structure; and
said computer is further operable to control an establishment of a second spatial column within the relational database for storing a third set of spatial data corresponding to a duration of any product on the shelf.

10. The system of claim 9, wherein
said computer is further operable to control an establishment of an attribute column within the relational database for storing attribute data corresponding to the product located on the shelf.

11. A computer program product in a computer readable medium for mapping a product located on a shelf within an isle contained within a structure, said computer program product comprising:
computer readable code for establishing a spatial reference system encompassing the shelf based upon a coordinate reference system encompassing an interior of the structure; and
computer readable code for establishing the shelf as a geographical entity within the spatial reference system in terms of a position of the shelf within the isle, a location of the isle within the structure, and a duration of a product on the shelf.

12. The computer program product of claim 11, further comprising:
computer readable code for establishing a spatial column for storing spatial data corresponding to the geographical entity.

13. The computer program product of claim 12, further comprising:
computer readable code for establishing an attribute column within the relational database for storing attribute data corresponding to the product located on the shelf.

14. The computer program product of claim 11, further comprising:
computer readable code for establishing a first spatial column for storing a first set of spatial data corresponding to the position of the shelf within the isle and the location of the isle within the structure; and
computer readable code for establishing a second spatial column for storing a second set of spatial data corresponding to a duration of any product on the shelf.

15. The computer program product of claim 14, further comprising:
computer readable code for establishing an attribute column within the relational database for storing attribute data corresponding to the product located on the shelf.

16. A method for mapping a shelf within an isle contained within a structure, said method comprising:
establishing a spatial reference system encompassing the shelf based upon a coordinate reference system encompassing an interior of the structure; and
establishing the shelf as a geographical entity within the spatial reference system in terms of a position of the shelf within the isle, and a location of the isle within the structure.

17. The method of claim 16, further comprising:
establishing a spatial column for storing a set of spatial data corresponding to the geographical entity.

18. The method of claim 16, further comprising:
establishing a first spatial column for storing a first set of spatial data corresponding to the position of the shelf within the isle and the location of the isle within the structure;
establishing a second spatial column for storing a second set of spatial data corresponding to a duration of the product on the shelf.

19. A system for mapping a shelf within an isle contained within a structure, said method comprising:
a computer operable to control an establishment of a spatial reference system encompassing the shelf based upon a coordinate reference system encompassing an interior of the structure, said computer further operable to control an establishment of the shelf as a geographical entity within the spatial reference system in terms of a position of the shelf within the isle and a location of the isle within the structure; and
a relational database operable to store spatial data corresponding to the geographical entity.

20. The system of claim 19, wherein
said computer is further operable to control an establishment of a spatial column within the relational database for storing the spatial data corresponding to the geographical entity.

21. The system of claim 19, wherein
said computer is further operable to control an establishment of a first spatial column within the relational database for storing a first set of spatial data corresponding to the position of the shelf within the isle and the location of the isle within the structure; and
said computer is further operable to control an establishment of a second spatial column within the relational database for storing a third set of spatial data corresponding to a duration of any product on the shelf.

22. A computer program product in a computer readable medium for mapping a shelf within an isle contained within a structure, said computer program product comprising:
computer readable code for establishing a spatial reference system encompassing the shelf based upon a coordinate reference system encompassing an interior of the structure; and
computer readable code for establishing the shelf as a geographical entity within the spatial reference system in terms of a position of the shelf within the isle and a location of the isle within the structure.

23. The computer program product of claim 22, further comprising:
computer readable code for establishing a spatial column for storing spatial data corresponding to the geographical entity.

24. The computer program product of claim 22, further comprising:
computer readable code for establishing a first spatial column for storing a first set of spatial data corresponding to the position of the shelf within the isle and the location of the isle within the structure; and
computer readable code for establishing a second spatial column for storing a second set of spatial data corresponding to a duration of any product on the shelf.
